(19) United States
(12) Patent Application Publication
(10) Pub. No.: US 2026/0101370 A1
(43) Pub. Date: Apr. 9, 2026

(54) COMMUNICATION DEVICE AND METHOD FOR HANDLING CHANNEL AVAILABILITY CHECK FOR COMMUNICATION DEVICE

(71) Applicant: MEDIATEK INC., Hsinchu City (TW)

(72) Inventors: Shao-Chung Sung, Hsinchu City (TW); Kun-Yuan Hsiao, Hsinchu (TW)

(73) Assignee: MEDIATEK INC., Hsinchu City (TW)

(21) Appl. No.: 18/909,958

(22) Filed: Oct. 9, 2024

Related U.S. Application Data
(60) Provisional application No. 63/591,791, filed on Oct. 20, 2023.

(51) Int. Cl. H04W 74/0808

(52) U.S. Cl. CPC H04W 74/0808

(57) ABSTRACT

A communication device including: a central processing unit (CPU), configured to select a first target channel from a plurality of candidate target channel and configure a first non-dynamic frequency selection (non-DFS) channel as an in-use channel, in response to the first target channel being a DFS channel; a channel availability check (CAC) circuit, coupled to the CPU and configured to perform a first CAC for the first target channel to generate a first CAC result, in response to the first target channel being the DFS channel; and a communication circuit, coupled to the CPU and configured to perform at least one communication operation on the first non-DFS channel during the first CAC and perform the at least one communication operation on the first target channel, in response to the first CAC result being successful.

### CROSS REFERENCE TO RELATED APPLICATIONS

This application claims the benefit of U.S. Provisional Application No. 63/591,791, filed on Oct. 20, 2023. The content of the application is incorporated herein by reference.

### BACKGROUND

A channel availability check (CAC) applies to a communication device which is capable of detecting radar signals. In the CAC, the communication device scans a dynamic frequency selection (DFS) channel for radar signals at least 60 seconds. During the CAC, the communication device suspends the signal transmission/reception for a CAC wait time, i.e., cannot transmit and receive any signal on the DFS channel. It results in transmission latency. Thus, how to handle the CAC for the communication device to avoid the transmission latency is an important problem to be solved.

### SUMMARY

It is an objective of the invention to provide a communication device and a method, in order to solve the above problem.

An embodiment of the invention provides a communication device comprising a central processing unit (CPU), configured to select a first target channel from a plurality of candidate target channel and configure a first non-dynamic frequency selection (non-DFS) channel as an in-use channel, in response to the first target channel being a DFS channel; a channel availability check (CAC) circuit, coupled to the CPU and configured to perform a first CAC for the first target channel to generate a first CAC result, in response to the first target channel being the DFS channel; and a communication circuit, coupled to the CPU and configured to perform at least one communication operation on the first non-DFS channel during the first CAC and perform the at least one communication operation on the first target channel, in response to the first CAC result being successful.

An embodiment of the invention provides a method for handling a channel availability check (CAC) for a communication device comprising: selecting a first target channel from a plurality of candidate target channel; configuring a first non-dynamic frequency selection (non-DFS) channel as an in-use channel, in response to the first target channel being a DFS channel; performing a first CAC for the first target channel to generate a first CAC result, in response to the first target channel being the DFS channel; performing at least one communication operation on the first non-DFS channel during the first CAC; and performing the at least one communication operation on the first target channel, in response to the first CAC result being successful.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication system according to an embodiment of the invention.

FIG. 2 is an exemplary block diagram of a communication device according to an embodiment of the invention.

FIG. 3 is a flowchart of a process according to an embodiment of the invention.

FIG. 4 is a sequence diagram of a process according to an embodiment of the invention.

FIG. 5 is a sequence diagram of a process according to an embodiment of the invention.

FIG. 6 is a sequence diagram of a process according to an embodiment of the invention.

FIG. 7 is a flowchart of a process according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

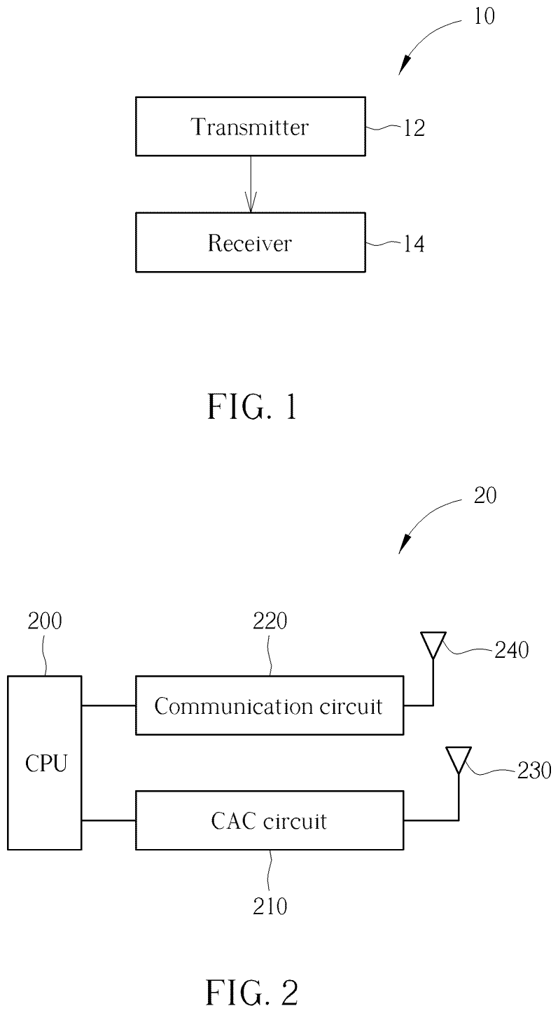

FIG. 1 is an exemplary block diagram of a communication system 10 according to an embodiment of the invention. The communication system 10 may be any communication system using an orthogonal frequency-division multiplexing (OFDM) technique (also termed a discrete multi-tone modulation (DMT) technique), and is composed of a transmitter 12 and a receiver 14. The communication system 10 may be any wireless communication system such as a wireless local area network (WLAN), a Digital Video Broadcasting (DVB) system, a Long Term Evolution (LTE) system, a Long Term Evolution-advanced (LTE-A) system or a fifth generation (5G) new radio (NR) system, but is not limited herein. In addition, the transmitter 12 and the receiver 14 may be a mobile phone, a laptop, a tablet computer, an access point (AP), an internet of things (IoT) device, a device-to-device (D2D) communication device, a portable computer system, etc., but is not limited herein.

FIG. 2 is an exemplary block diagram of a communication device 20 according to an embodiment of the invention. The communication device 20 may be the transmitter 12 or the receiver 14 in FIG. 1, but is not limited herein. The communication device 20 comprises a central processing unit (CPU) 200, a channel availability check (CAC) circuit 210, a communication circuit 220, an antenna 230 and an antenna 240. The CPU 200 may be a processor, and is a core component responsible for controlling and executing the operations of the communication device 20. For example, the CPU 200 is configured to select a target channel, e.g., when a radar signal is detected on an in-use channel. The CAC circuit 110 coupled to the CPU 200 and the antenna 230 is a dedicated circuit responsible for confirming whether the CPU-selected channel is available for the communication circuit 220 by performing a CAC. The CAC circuit 110 confirms that the CPU-selected channel is available, in response to a radar signal being not detected on the CPU-selected channel via the antenna 230. The CAC circuit 110 confirms that the CPU-selected channel is not available, in response to a radar signal being detected on the CPU-selected channel via the antenna 230. The communication circuit 220 coupled to the CPU 200 and the antenna 240 is a circuit responsible for communicating with other communication device via the antenna 240 on the in-use channel.

It should be noted that there are various possible realizations of the communication device 20 (including the CPU 200, the CAC circuit 210, the communication circuit 220, an antenna 230 and an antenna 240). For example, the circuits mentioned above may be integrated into one or more circuits. In addition, the communication device 20 may be realized by hardware (e.g., circuits), software, firmware (known as a combination of a hardware device, computer instructions and data that reside as read-only software on the hardware device), an electronic system or a combination of the devices mentioned above, but are not limited herein.

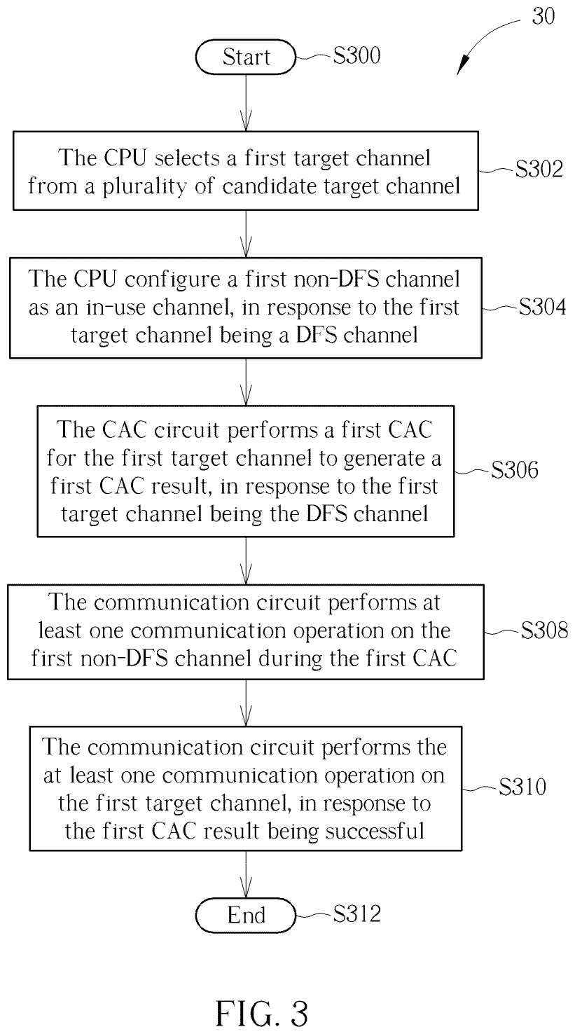

FIG. 3 is a flowchart of a process 30 utilized in a communication device (e.g., the communication device 20 shown in FIG. 2) according to an embodiment of the invention, to handle a CAC for the communication device. The communication device comprises a CPU, a CAC circuit and a communication circuit. Provided that the result is substantially the same, the steps are not required to be executed in the exact order shown in FIG. 3. The process 30 comprises the following steps:

Step S300: Start.

Step S302: The CPU selects a first target channel from a plurality of candidate target channel.

Step S304: The CPU configure a first non-dynamic frequency selection (non-DFS) channel as an in-use channel, in response to the first target channel being a DFS channel.

Step S306: The CAC circuit performs a first CAC for the first target channel to generate a first CAC result, in response to the first target channel being the DFS channel.

Step S308: The communication circuit performs at least one communication operation on the first non-DFS channel during the first CAC.

Step S310: The communication circuit performs the at least one communication operation on the first target channel, in response to the first CAC result being successful.

Step S312: End.

In the process 30, Step S304 can be skipped if the non-DFS has been configured as the in-use channel.

Realization of the process 30 is not limited to the above description. The following embodiments of the invention may be applied to realize the process 30.

In an embodiment of the invention, the CPU selects the first target channel from the plurality of candidate target channel, in response to the communication device intending to manually switch the in-use channel. In an embodiment of the invention, the CPU selects the first target channel from the plurality of candidate target channel, in response to a radar signal being detected on the in-use channel.

In an embodiment of the invention, the CPU requests the CAC circuit to perform the first CAC for the first target channel in response to the first target channel being the DFS channel, after selecting the first target channel from the plurality of candidate target channel. In an embodiment of the invention, the CPU selects a second target channel from the plurality of candidate target channel, in response to the first CAC result being failed. In an embodiment of the invention, the CPU selects the second target channel from the plurality of candidate target channel, in response to a radar signal being detected on the first target channel when performing the at least one communication operation on the first target channel.

In an embodiment of the invention, the CAC circuit performs a second CAC for the second target channel to generate a second CAC result, in response to the second target channel being the DFS channel. In an embodiment of the invention, the communication circuit performs the at least one communication operation on the second target channel, in response to the second CAC result being successful.

In an embodiment of the invention, the CPU requests the CAC circuit to perform the second CAC for the second target channel in response to the second target channel being the DFS channel, after selecting the second target channel from the plurality of candidate target channel. In an embodiment of the invention, the CPU configures (e.g. sets) a second non-DFS channel as an in-use channel, in response to the second target channel being the DFS channel, e.g., before performing the second CAC for the second target channel. In an embodiment of the invention, the communication circuit performs the at least one communication operation on the second non-DFS channel during the second CAC.

In an embodiment of the invention, the CPU selects a third target channel from the plurality of candidate target channel, in response to the second CAC result being failed. In an embodiment of the invention, the CPU selects the third target channel from the plurality of candidate target channel, in response to a radar signal being detected on the second target channel when performing the at least one communication operation on the second target channel. Operations related to the third target channel can be referred the embodiments of the invention related to the second target channel, and are not narrated herein for brevity.

In an embodiment of the invention, the communication circuit performs the at least one communication operation on the first target channel, in response to the first target channel being not the DFS channel. In an embodiment of the invention, the communication circuit performs the at least one communication operation on the second target channel, in response to the second target channel being not the DFS channel.

In an embodiment of the invention, an operation of performing the at least one communication operation, e.g., on the first target channel, comprises but not limited to at least one of following operations: transmitting at least one signal (such as data, message and/or packet) to other communication device, e.g., on the first target channel; and receiving the at least one signal (such as data, message and/or packet) from the other communication device, e.g., on the first target channel. In an embodiment of the invention, the at least one communication operation is available and (e.g., always) connectable on the non-DFS channel.

In an embodiment of the invention, the CAC result is successful means that a radar signal is not detected on a target channel (e.g., the first/second/third target channel) during the CAC, i.e., the target channel is not available for the communication circuit. In an embodiment of the invention, the CAC result is failed means that the radar signal is detected on the target channel (e.g., the first/second/third target channel) during the CAC, i.e., the target channel is available for the communication circuit. In an embodiment of the invention, when the radar signal is detected on the target channel, the CAC circuit immediately stops performing the CAC and then the CPU selects a new target channel. In an embodiment of the invention, if the radar signal is detected on the target channel, the communication circuit is not able to perform the at least one communication operation on the target channel in time period (e.g., 30 minutes).

In an embodiment of the invention, the radar signal is used for a military or for a weather detection, but is not limited herein. In an embodiment of the invention, the DFS channel and the non-DES channel are defined in a communication standard (e.g., IEEE 802.11 a/n/ac/h). For example, the non-DFS channel may be one of channels 36-48 defined in IEEE 802.11 h. In an embodiment of the invention, a time taking to perform a CAC (e.g., the first/second CAC) is greater than 60 seconds. In an embodiment of the invention, the time taking to perform the CAC (e.g., the first/second CAC) is less than 600 seconds. In an embodiment of the invention, the CAC circuit is offline, when the CAC circuit does not perform the CAC.

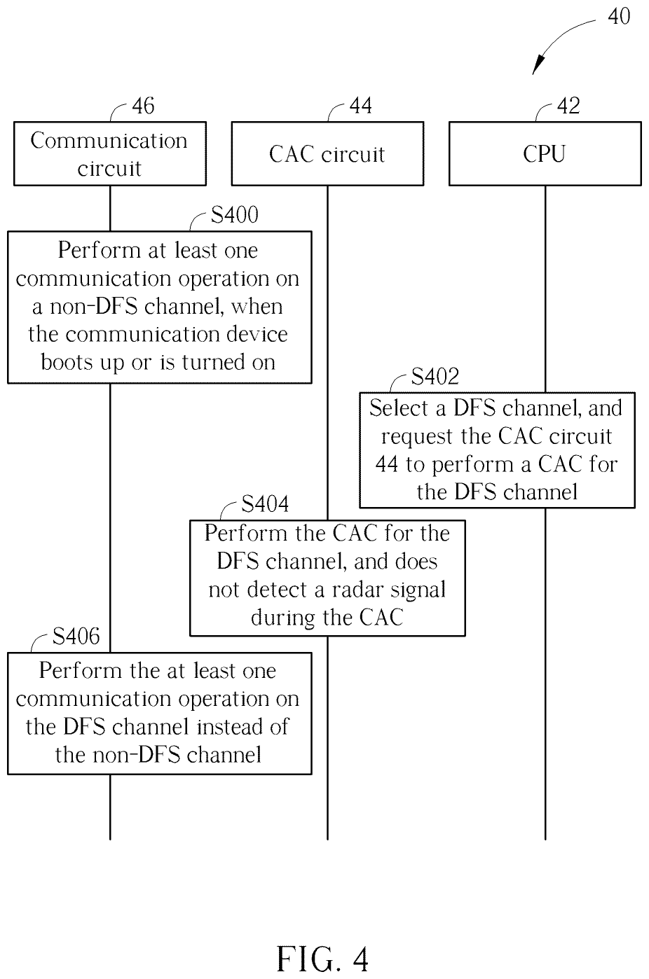

FIG. 4 is a sequence diagram of a process 40 according to an embodiment of the invention. A communication device (e.g., the communication device 20 in FIG. 2) comprises a CPU 42, a CAC circuit 44 and a communication circuit 46. In Step S400, the communication circuit 46 performs at least one communication operation on a non-DFS channel, when the communication device boots up or is turned on. In Step S402, the CPU 42 selects a DFS channel, and requests the CAC circuit 44 to perform a CAC for the DFS channel. In Step S404, the CAC circuit 44 performs the CAC for the DFS channel, and does not detect a radar signal during the CAC (i.e., a CAC result is successful). Then, In Step S406, the communication circuit 46 performs the at least one communication operation on the DFS channel instead of the non-DFS channel. That is, an in-use channel of the communication circuit 46 is the non-DFS channel when the CAC circuit 44 performs the CAC, and the communication circuit 46 switches the in-use channel to the DFS channel in response to the radar signal being not detected during the CAC.

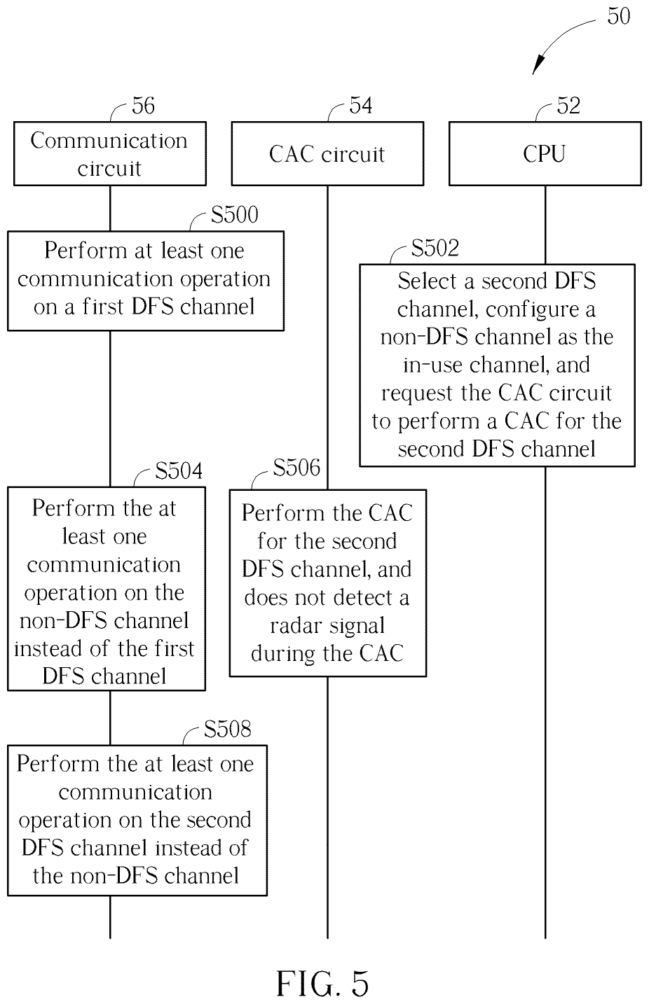

FIG. 5 is a sequence diagram of a process 50 according to an embodiment of the invention. A communication device (e.g., the communication device 20 in FIG. 2) comprises a CPU 52, a CAC circuit 54 and a communication circuit 56. In Step S500, the communication circuit 56 performs at least one communication operation on a first DFS channel. The first DFS channel is an in-use channel of the communication circuit 56. In Step S502, the CPU 56 selects a second DFS channel, configures a non-DFS channel as the in-use channel, and requests the CAC circuit 54 to perform a CAC for the second DFS channel. In an embodiment of Step S502, the CPU 56 selects the second DFS channel, in response to the communication device intending to manually switch the in-use channel. In an embodiment of Step S502, the CPU 56 selects the second DFS channel, in response to a radar signal being detected on the in-use channel. In Step S504, the communication circuit 56 performs the at least one communication operation on the non-DFS channel instead of the first DFS channel.

In Step S506, the CAC circuit 54 performs the CAC for the second DFS channel, and does not detect a radar signal during the CAC (i.e., a CAC result is successful). Then, in Step S508, the communication circuit 56 performs the at least one communication operation on the second DFS channel instead of the non-DFS channel. That is, the in-use channel of the communication circuit 56 is switched from the first DFS channel to the non-DFS channel before the CAC circuit 54 performs the CAC, and switched from the non-DFS channel to the second DFS channel in response to the radar signal being not detected during the CAC. Thus, the in-use channel of the communication circuit 56 is the non-DFS channel, when the CAC circuit 54 performs the CAC. It should be noted that a time taking to switch from the first DFS channel to the non-DFS channel is less than 1 second.

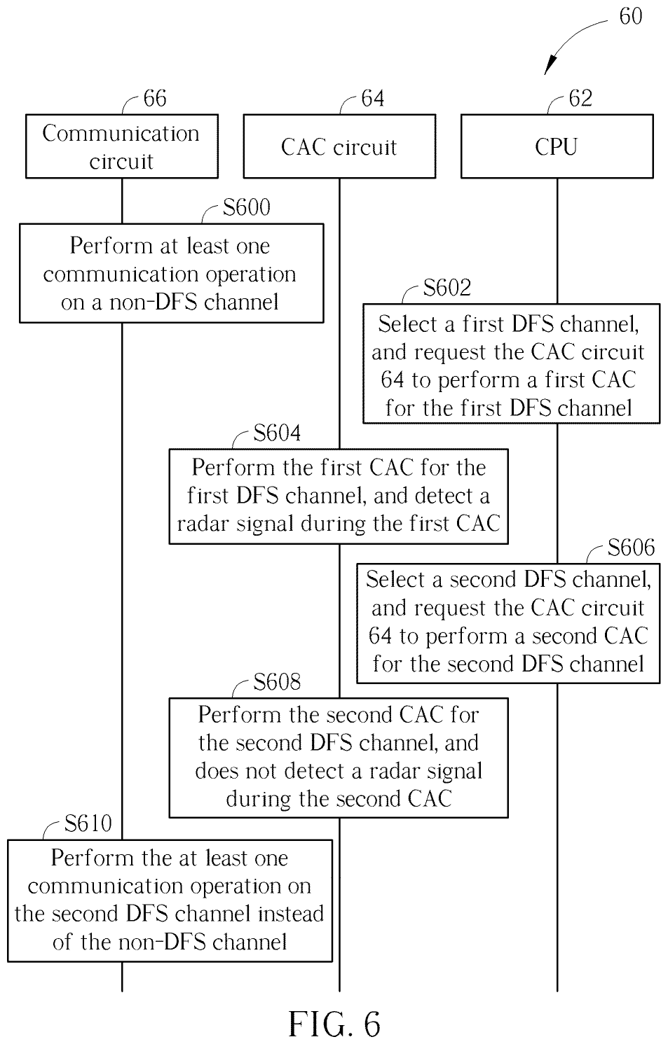

FIG. 6 is a sequence diagram of a process 60 according to an embodiment of the invention. A communication device (e.g., the communication device 20 in FIG. 2) comprises a CPU 62, a CAC circuit 64 and a communication circuit 66. In Step S600, the communication circuit 66 performs at least one communication operation on a non-DFS channel. In Step S602, the CPU 62 selects a first DFS channel, and requests the CAC circuit 64 to perform a first CAC for the first DFS channel. In Step S604, the CAC circuit 64 performs the first CAC for the first DFS channel, and detects a radar signal during the first CAC (i.e., a first CAC result is failed). In Step S606, the CPU 62 selects a second DFS channel, and requests the CAC circuit 64 to perform a second CAC for the second DFS channel.

In Step S608, the CAC circuit 64 performs the second CAC for the second DFS channel, and does not detect a radar signal during the second CAC (i.e., a second CAC result is successful). Then, in Step S610, the communication circuit 66 performs the at least one communication operation on the second DFS channel instead of the non-DFS channel. That is, an in-use channel of the communication circuit 66 is the non-DFS channel when the CAC circuit 64 performs the CAC, and the communication circuit 66 switches the in-use channel to the second DFS channel rather than the first DFS channel in response to the radar signal being not detected during the second CAC.

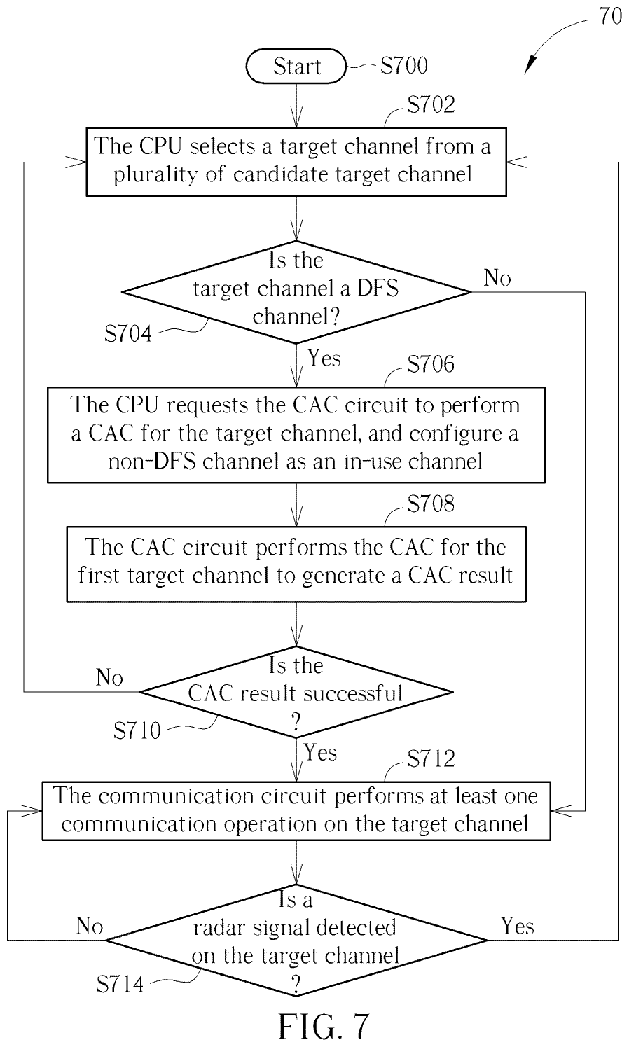

FIG. 7 is a flowchart of a process 70 according to an embodiment of the invention. Operations of the communication device in the above embodiments can be summarized into the process 70. The process 70 comprises the following steps:

Step S700: Start.

Step S702: The CPU selects a target channel from a plurality of candidate target channel.

Step S704: Is the target channel a DFS channel? If yes, perform Step S706. If no, perform Step S712.

Step S706: The CPU requests the CAC circuit to perform a CAC for the target channel, and configure a non-DFS channel as an in-use channel.

Step S708: The CAC circuit performs the CAC for the first target channel to generate a CAC result.

Step S710: Is the CAC result successful? If yes, perform Step S712. If no, perform Step S714.

Step S712: The communication circuit performs at least one communication operation on the target channel.

Step S714: Is a radar signal detected on the target channel? If yes, perform Step S702. If no, perform Step S712.

In the process 70, the communication circuit performs the at least one communication operation on the non-DFS channel, when the CAC circuit performs the CAC. The process 70 is terminated when at least one event occur. The at least one event comprises but not limited to at least one of following events: the communication device is turned off or shut down; and the communication device enters a sleeping mode or an idle mode.

Detailed descriptions and variations of the process 70 can be known by referring to the previous description, and are not narrated herein.

The phrase “related to” described above may be replaced by “of” or “associated with”. The term “via” described above may be replaced by “on”, “in” or “at”. The terms “when” and “if” described above may be replaced by “upon” or “in response to”.

To sum up, the present invention provides a communication device and a method for handling a CAC for the communication device. A communication circuit of the communication device operates on a non-DFS channel, when a CAC circuit of the communication device performs the CAC for a DFS channel. Thus, the transmission latency caused by the CAC can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a central processing unit (CPU), configured to:
select a first target channel from a plurality of candidate target channel; and
configure a first non-dynamic frequency selection (non-DFS) channel as an in-use channel, in response to the first target channel being a DFS channel;
a channel availability check (CAC) circuit, coupled to the CPU and configured to:
perform a first CAC for the first target channel to generate a first CAC result, in response to the first target channel being the DFS channel; and
a communication circuit, coupled to the CPU and configured to:
perform at least one communication operation on the first non-DFS channel during the first CAC; and
perform the at least one communication operation on the first target channel, in response to the first CAC result being successful.

2. The communication device of claim 1, wherein the CPU is further configured to:
request the CAC circuit to perform the first CAC for the first target channel in response to the first target channel being the DFS channel, after selecting the first target channel from the plurality of candidate target channel.

3. The communication device of claim 1, wherein the CPU is further configured to perform at least one of following operations:
selecting a second target channel from the plurality of candidate target channel, in response to the first CAC result being failed; and
selecting the second target channel from the plurality of candidate target channel, in response to a radar signal being detected on the first target channel when performing the at least one communication operation on the first target channel.

4. The communication device of claim 3, wherein the CAC circuit is further configured to:
perform a second CAC for the second target channel to generate a second CAC result, in response to the second target channel being the DFS channel; and
the communication circuit is further configured to:
perform the at least one communication operation on the second target channel, in response to the second CAC result being successful.

5. The communication device of claim 4, wherein the CPU is further configured to perform at least one of following operations:
requesting the CAC circuit to perform the second CAC for the second target channel in response to the second target channel being the DFS channel, after selecting the second target channel from the plurality of candidate target channel; and
configuring a second non-DFS channel as an in-use channel, in response to the second target channel being the DFS channel.

6. The communication device of claim 5, wherein the communication circuit is further configured to:
perform the at least one communication operation on the second non-DFS channel during the second CAC.

7. The communication device of claim 4, wherein the CPU is further configured to perform at least one of following operations:
selecting a third target channel from the plurality of candidate target channel, in response to the second CAC result being failed; and
selecting the third target channel from the plurality of candidate target channel, in response to a radar signal being detected on the second target channel when performing the at least one communication operation on the second target channel.

8. The communication device of claim 1, wherein the communication circuit is further configured to:
perform the at least one communication operation on the first target channel, in response to the first target channel being not the DFS channel.

9. The communication device of claim 1, wherein an operation of performing the at least one communication operation comprises at least one of following operations:
transmitting at least one signal to other communication device; and
receiving the at least one signal from the other communication device.

10. A method for handling a channel availability check (CAC) for a communication device, comprising:
selecting a first target channel from a plurality of candidate target channel;
configuring a first non-dynamic frequency selection (non-DFS) channel as an in-use channel, in response to the first target channel being a DFS channel;
performing a first CAC for the first target channel to generate a first CAC result, in response to the first target channel being the DFS channel;
performing at least one communication operation on the first non-DFS channel during the first CAC; and
performing the at least one communication operation on the first target channel, in response to the first CAC result being successful.

11. The method of claim 10, further comprising:
requesting to perform the first CAC for the first target channel in response to the first target channel being the DFS channel, after selecting the first target channel from the plurality of candidate target channel.

12. The method of claim 10, further comprising at least one of following steps:
selecting a second target channel from the plurality of candidate target channel, in response to the first CAC result being failed; and
selecting the second target channel from the plurality of candidate target channel, in response to a radar signal being detected on the first target channel when performing the at least one communication operation on the first target channel.

13. The method of claim 12, further comprising:
performing a second CAC for the second target channel to generate a second CAC result, in response to the second target channel being the DFS channel; and
performing the at least one communication operation on the second target channel, in response to the second CAC result being successful.

14. The method of claim 13, further comprising at least one of following steps:
requesting to perform the second CAC for the second target channel in response to the second target channel being the DFS channel, after selecting the second target channel from the plurality of candidate target channel; and
configuring a second non-DFS channel as an in-use channel, in response to the second target channel being the DFS channel.

15. The method of claim 14, further comprising:
performing the at least one communication operation on the second non-DFS channel during the second CAC.

16. The method of claim 13, further comprising at least one of following steps:
selecting a third target channel from the plurality of candidate target channel, in response to the second CAC result being failed; and
selecting the third target channel from the plurality of candidate target channel, in response to a radar signal being detected on the second target channel when performing the at least one communication operation on the second target channel.

17. The method of claim 10, further comprising:
performing the at least one communication operation on the first target channel, in response to the first target channel being not the DFS channel.

18. The method of claim 10, wherein a step of performing the at least one communication operation comprises at least one of following steps:
transmitting at least one signal to other communication device; and
receiving the at least one signal from the other communication device.
